(19) United States
(12) Patent Application Publication
(10) Pub. No.: US 2013/0275182 A1
(43) Pub. Date: Oct. 17, 2013

(54) SOCIAL AUDIENCE ANALYSIS

(71) Applicant: Compass Labs, Inc., San Jose, CA (US)

(72) Inventors: Venkatachari Dilip, Cupertino, CA (US); Arjun Jayaram, Fremont, CA (US); Michael Palmer, Corrales, NM (US); Sumant Yerramilly, San Jose, CA (US); Vivek Seghal, San Jose, CA (US)

(21) Appl. No.: 13/758,940

(22) Filed: Feb. 4, 2013

Related U.S. Application Data
(60) Provisional application No. 61/594,197, filed on Feb. 2, 2012.

(51) Int. Cl. G06Q 30/02

(52) U.S. Cl. CPC G06Q 30/0204
USPC 705/7.33

(57) ABSTRACT

Example systems and methods of analyzing a social audience are described. In one implementation, a method receives social audience data associated with multiple users. The method identifies multiple preferences associated with the users based on the social audience data. The method further identifies demographic information associated with at least a portion of the users. At least one characteristic of the users is determined based on the multiple preferences and the demographic information.

### RELATED APPLICATION

This application claims the priority benefit of U.S. Provisional Application Ser. No. 61/594,197, entitled “Social Audience Analysis”, filed Feb. 2, 2012, the disclosure of which is incorporated herein by reference in its entirety.

### TECHNICAL FIELD

The present disclosure generally relates to data processing techniques and, more specifically, to systems and methods for analyzing social audience information.

### BACKGROUND

Interaction among users through online systems and services, such as social media sites, social networks, blogs, microblogs, and the like, is increasing at a rapid rate. These online systems and services provide different forms of content and allow users to share various types of information. Additionally, these systems and services allow users to exchange ideas, stories, comments, pictures, and other information among their friends and acquaintances.

### BRIEF DESCRIPTION OF THE DRAWINGS

Some embodiments are illustrated by way of example and not limitation in the figures of the accompanying drawings.

FIG. 1 is a block diagram depicting an example environment used to implement the systems and methods discussed herein.

FIG. 2 is a flow diagram illustrating an example procedure for analyzing and processing social audience data.

FIG. 3 illustrates example procedures and analysis of social audience data.

FIG. 4 illustrates an example methodology for analyzing social audience data.

FIG. 5 illustrates example topics and terms identified in social audience data.

FIG. 6 illustrates example conversation topics associated with an entity's social audience.

FIG. 7 illustrates example engagement data associated with an entity's social audience.

FIG. 8 illustrates additional example engagement data associated with an entity's social audience.

FIG. 9 illustrates example engagement data associated with an entity's competitors.

FIG. 10 illustrates example sentiment data associated with an entity's social audience.

FIG. 11 illustrates example conclusions based on an entity's social audience.

FIG. 12 illustrates example recommendations based on an entity's social audience.

FIG. 13 is a block diagram of a machine in the example form of a computer system within which a set of instructions, for causing the machine to perform any one or more of the methodologies discussed herein, may be executed.

### DETAILED DESCRIPTION

This systems and methods discussed herein perform various operations, such as analyzing various communications and other information associated with various social networks and other communication networks/mechanisms. Example systems and methods to analyze user posts, status updates, social followers (or fans), social “likes”, and other communications, to provide data related to an entity's social audience. In the following description, for purposes of explanation, numerous specific details are set forth in order to provide a thorough understanding of example embodiments. It will be evident, however, to one skilled in the art that the present invention may be practiced without these specific details. Particular examples discussed herein refer to social activities on Facebook™. However, the systems and methods discussed herein are applicable to any type of social network activity as well as other user activities.

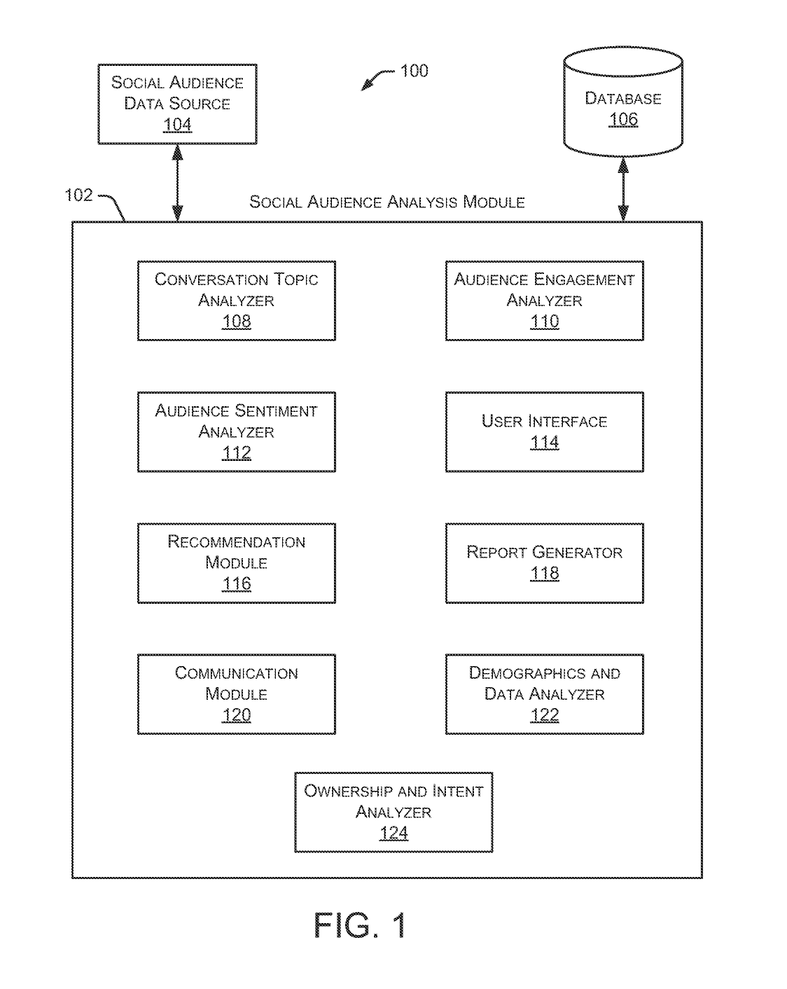

FIG. 1 is a block diagram depicting an example environment 100 used to implement the systems and methods discussed herein. A social audience analysis module 102 receives various types of data and information from a variety of sources, such as a social audience data source 104, which may include data stores, social networks, data communication networks, and any other source of data. The social audience data may also be referred to as “social media data” or “social network data.” A database 106 stores various information received by, generated by, and used by social audience analysis module 102.

Social audience analysis module 102 includes a conversation topic analyzer 108, which analyzes conversations contained in various social audience data. The conversation topic analyzer 108 identifies, for example, specific topics of conversations by users associated with a particular group or associated with a particular entity. Social audience analysis module 102 also includes an audience engagement analyzer 110, which analyzes the engagement level of users associated with a particular group or associated with a particular entity.

Social audience analysis module 102 further includes an audience sentiment analyzer 112, which analyzes various sentiment characteristics of users associated with a particular group or associated with a particular entity. Additionally, social audience analysis module 102 includes a user interface 114, which allows one or more users to access social audience analysis module 102 for purposes of administration, management, data access, report generation, and the like.

Social audience analysis module 102 further includes a recommendation module 116, which generates one or more recommendations, for example, for an entity or user based on the various analysis activities performed by social audience analysis module 102. Additionally, social audience analysis module 102 includes a report generator 118, which is capable of generating any number of reports associated with the social audience data and analysis of the social audience data. Social audience analysis module 102 also includes a communication module 120, which allows social audience analysis module 102 to communicate with social audience data source 104, database 106, and other devices/systems via one or more communication links (e.g., data communication networks and the like).

Social audience analysis module 102 also includes a demographics and data analyzer 122 that identifies and analyzes various demographic and related data. Demographic data includes, for example, age and gender. Other data analyzed by demographics and data analyzer 122 includes, for example, extended demographic information (such as income level, family size, and family type), geographic location, purchasing behavior (e.g., historical purchasing information), user preferences, user profile information, user interests, user activities, and the like. Finally, social audience analysis module 102 also includes an ownership and interest analyzer 124, which identifies products or services owned (or used) by particular users. For example, a particular user may be identified as a “home owner”, “car owner”, “gym membership owner”, and the like. This information may be identified, for example, from user profile information, user social media communications, user surveys, and other sources of user data, user activity, and user communications.

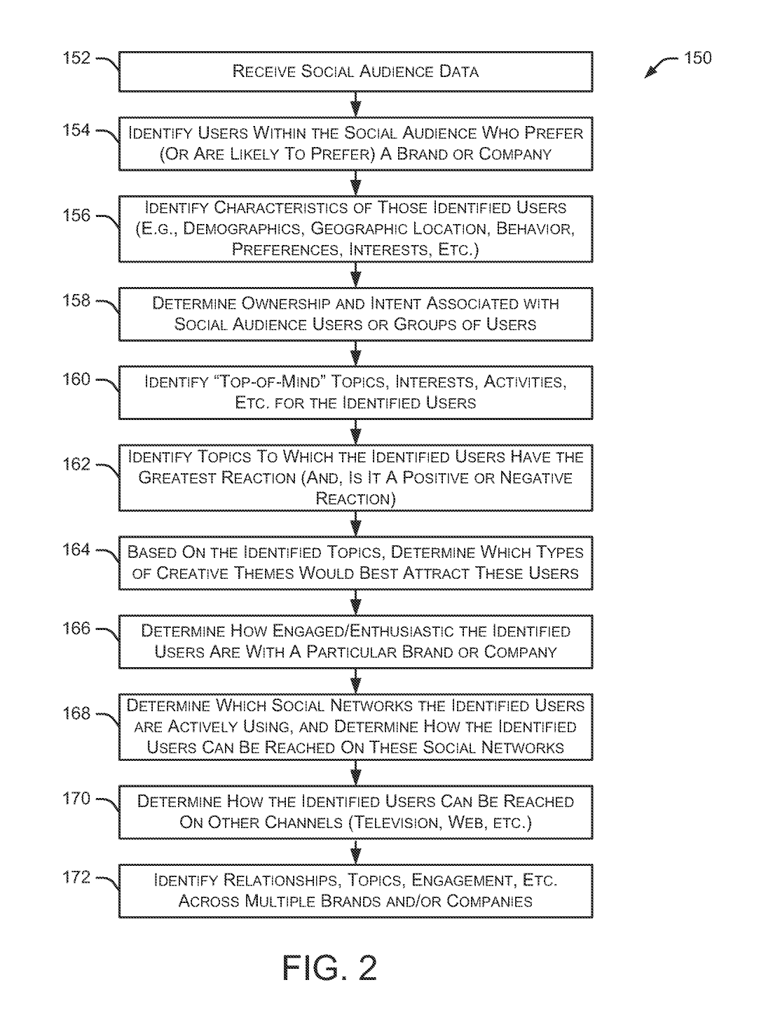

FIG. 2 is a flow diagram illustrating an example procedure 150 for analyzing and processing social audience data. FIG. 2 shows various steps and activities in a particular arrangement for convenience of discussion. In alternate embodiments, the steps shown in FIG. 2 can be performed in any order at different times. Additionally, one or more steps may be deleted from FIG. 2, and one or more other steps may be added to the procedure of FIG. 2. Although the steps of FIG. 2 are shown in a sequential order, any number of the steps shown in FIG. 2 can be performed in parallel with one another. For example, the procedure may “Identify characteristics of those interested users” and “Determine ownership and intent associated with social audience users or groups of users” simultaneously.

Initially, the procedure 152 receives social audience data at 152. The procedure 152 continues by identifying users within the social audience who prefer (or are likely to prefer) a brand or company at 154. Additionally, the procedure 152 identifies characteristics of those identified users at 156, such as demographics, geographic location, behavior, preferences, interests, and the like. The procedure 152 determines ownership and intent associated with social audience users and/or groups of users at 158. Top-of-mind topics, interests, activities, and the like are identified at 160 for the identified users.

The procedure 152 further identifies topics to which the identified users have the greatest reaction at 162. The type of reaction (e.g., positive or negative) is also identified at 162. Based on the identified topics, the procedure 152 determines which types of creative themes would best attract these users at 164, and determines how engaged (or enthusiastic) the identified users are with a particular brand or company at 166. Next, the procedure 152 determines which social networks the identified users are actively using, and determines how the identified users can be reached on these social networks at 168. The procedure 152 also determines how the identified users can be reached on other channels at 170, such as via television, Web, and the like. Finally, the procedure 152 identifies relationships, topics, engagements, and the like across multiple brands and/or companies at 172. These relationships, topics, and engagements are then stored for future reference, presented to one or more users, incorporated into a report, and the like.

In FIG. 2, the “top of mind” topics, interests, and activities refer to things that the identified users talk about the most (e.g., based on social media communications and the like). The social audience data analyzed in FIG. 2, and discussed herein, may be received from any number of different sources. These sources include social media networks, social networks, interest groups, online forums, blogs, blog posts, comments on any Web site, microblog posts, and so forth. When analyzing social audience data, the systems and methods described herein may analyze, for example, user communications, user comments, user profile information, user membership in groups, user participation in events or activities, user “likes” (e.g., “likes” of fan pages, entities, web sites, articles, social media posts, and so forth), user “follows” of individuals, entities, groups, interests, events, and the like.

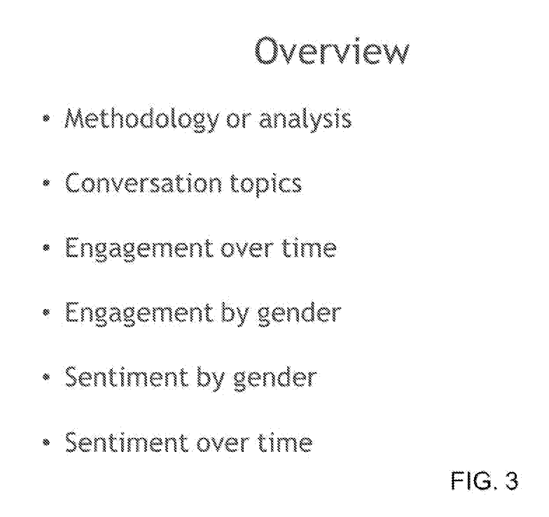

FIG. 3 illustrates example procedures and analysis of social audience data. In this example, various social audience data is analyzed to identify conversation topics, engagement of users over time, engagement of users based on gender, sentiment of users over time, and sentiment of users based on gender.

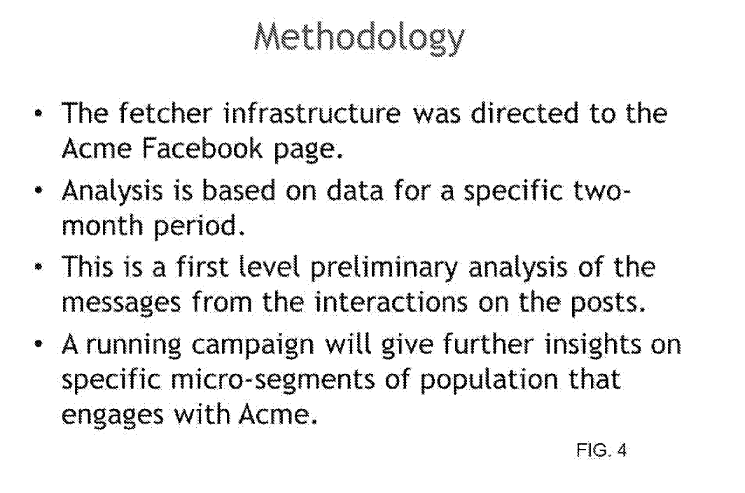

FIG. 4 illustrates an example methodology for analyzing social audience data. In this example, social audience is analyzed for a particular entity (Acme), such as a fan page or similar site associated with the entity. The methodology identifies a particular time period for which the analysis is performed. Various levels of analysis are available based on the type and detail of analysis results desired.

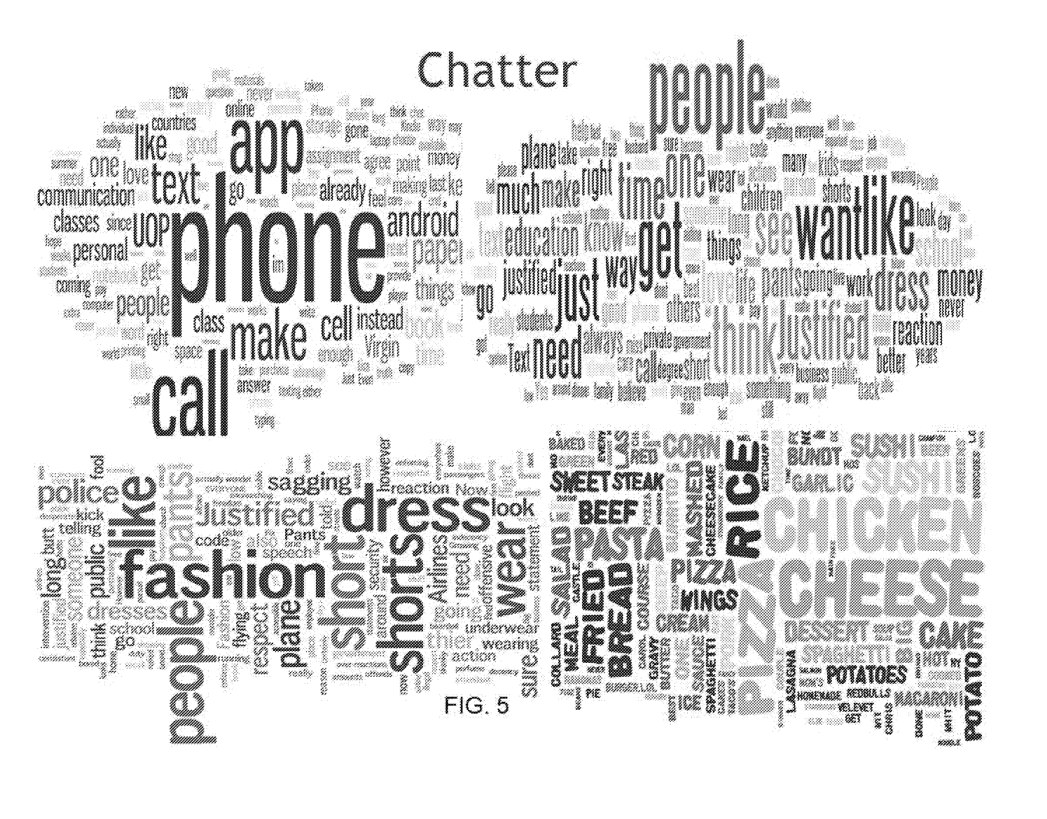

FIG. 5 illustrates example topics and terms identified in social audience data.

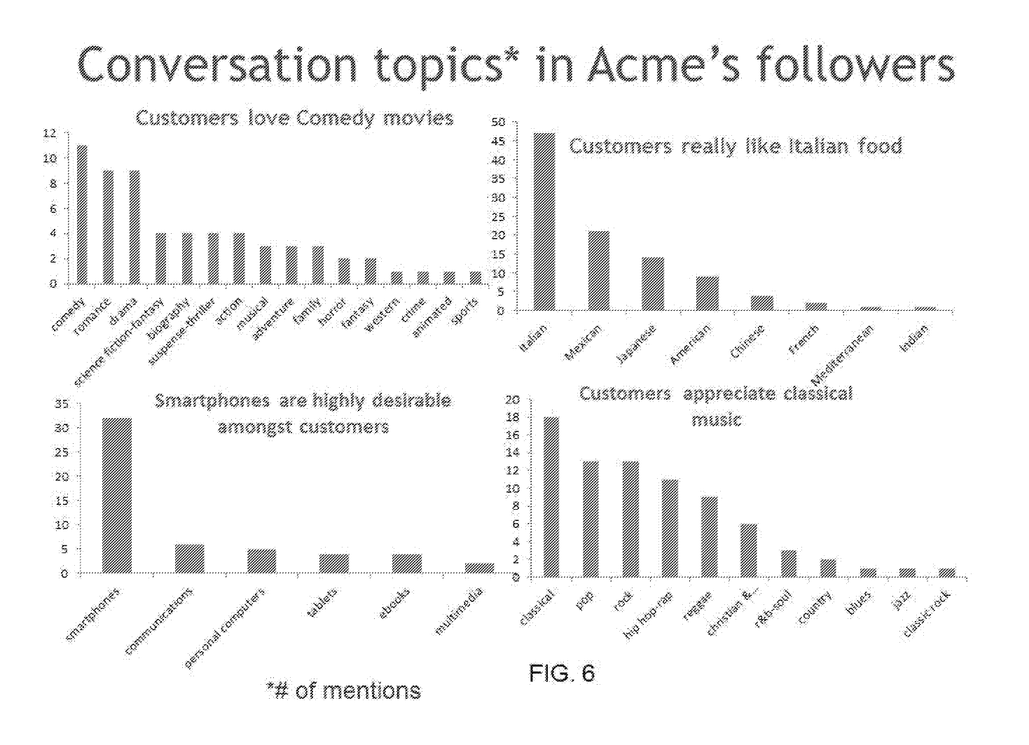

FIG. 6 illustrates example conversation topics associated with an entity's social audience. In the example of FIG. 6, the analysis indicates that Acme's customers enjoy comedy movies, Italian food, smartphones, and classical music. Other conversation topics are also displayed in the bar graphs, which represent the relative strength of interest in each topic by Acme's customers. In one embodiment, the bar graphs shown in FIG. 6 represent the number of times each topic is mentioned in the social audience data by Acme's customers.

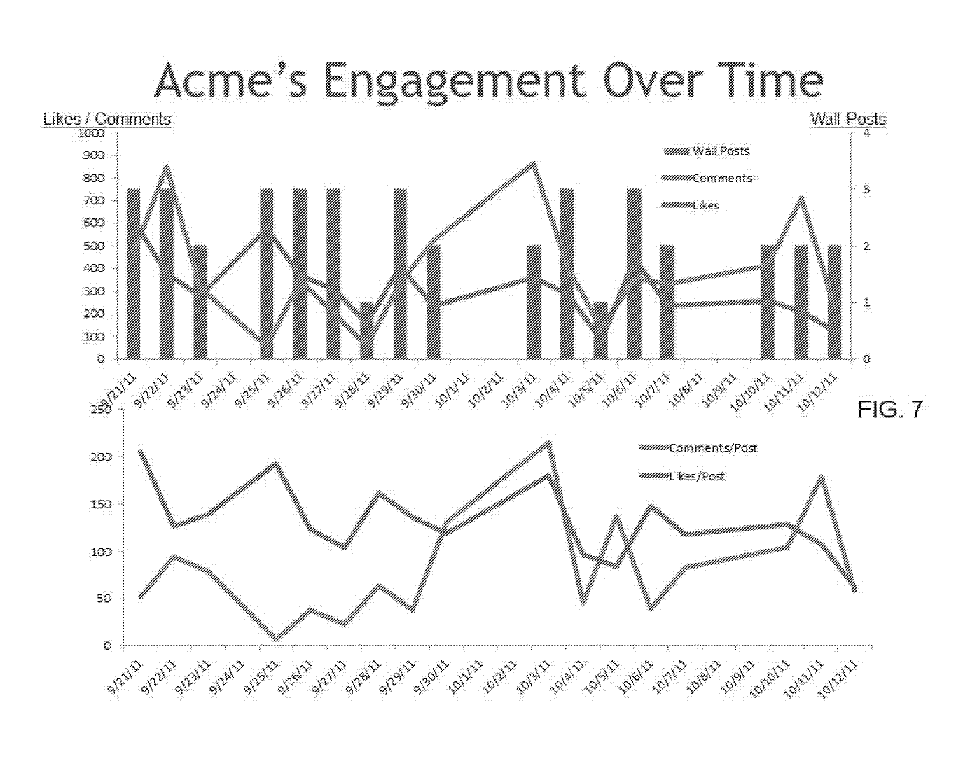

FIG. 7 illustrates example engagement data associated with an entity's social audience. The graphs shown in FIG. 7 illustrate engagement of Acme's customers over time. In this example, the engagement measures wall posts, comments, and likes by Acme's customers. Alternate embodiments may analyze and display any type of engagement by Acme's customers over any time period.

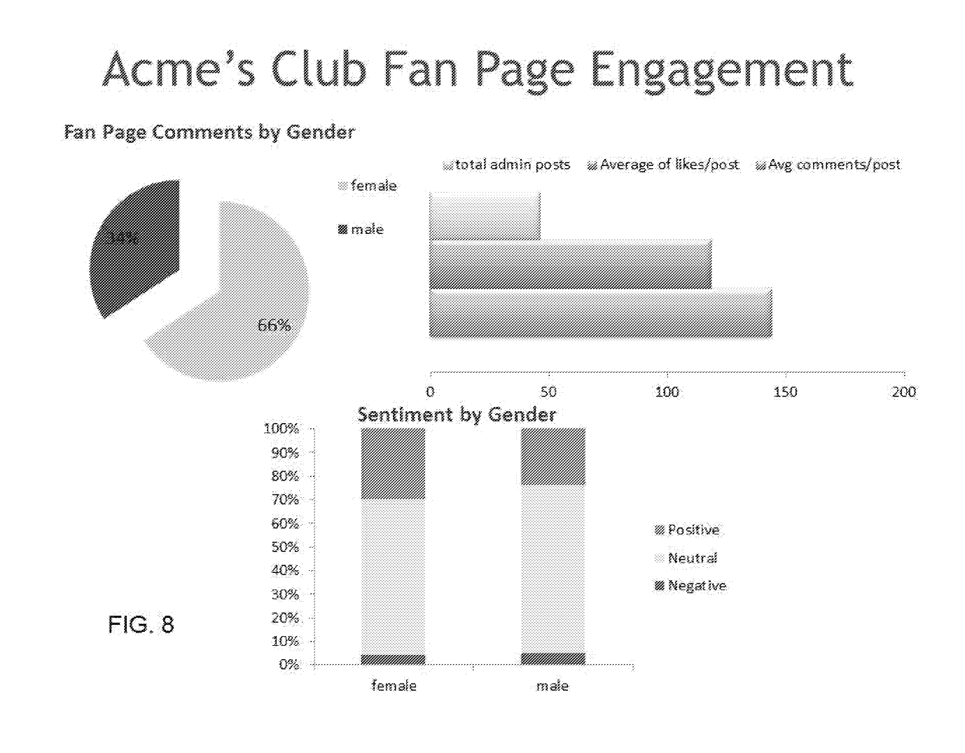

FIG. 8 illustrates additional example engagement data associated with an entity's social audience. In the example of FIG. 8, engagement is measured based on the total number of posts, the average number of likes per post, and the average number of comments per post. This data is further separated by gender. Sentiment (positive, neutral, and negative) is also monitored based on gender.

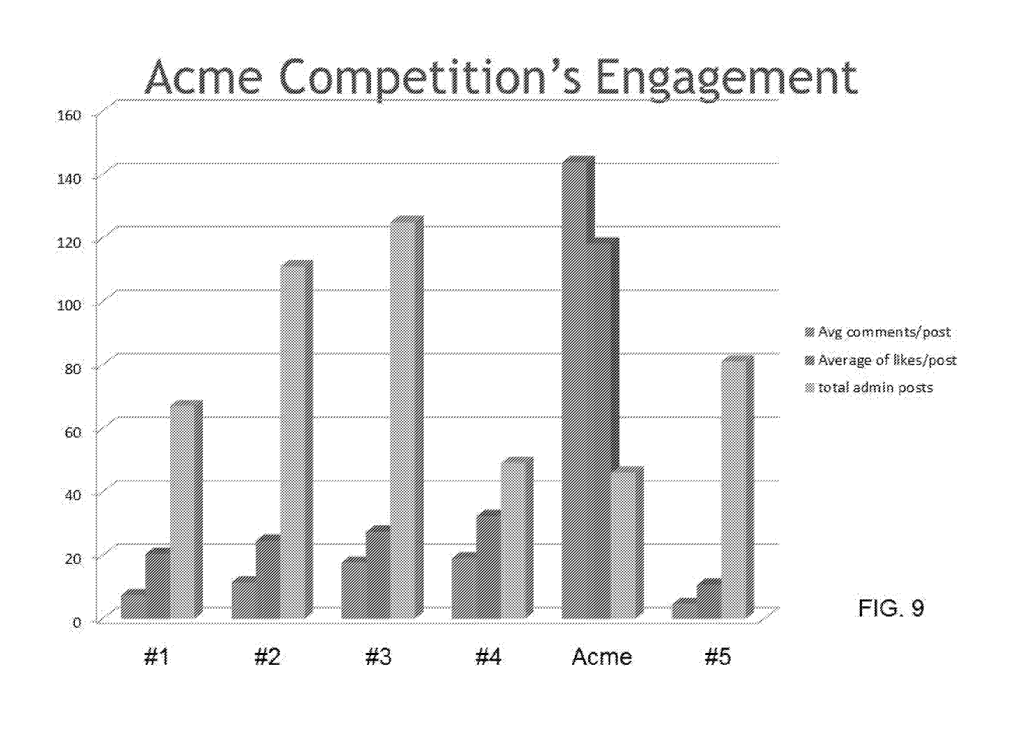

FIG. 9 illustrates example engagement data associated with an entity's competitors. The example of FIG. 9 displays engagement data associated with Acme as well as five of Acme's competitors. This allows, for example, managers of Acme to analyze Acme's engagement with users as compared to the engagement of Acme's competitors. In this example, Acme has the highest average number of comments per post and the highest average number of likes per post. However, Acme has fewer total admin posts than its competitors.

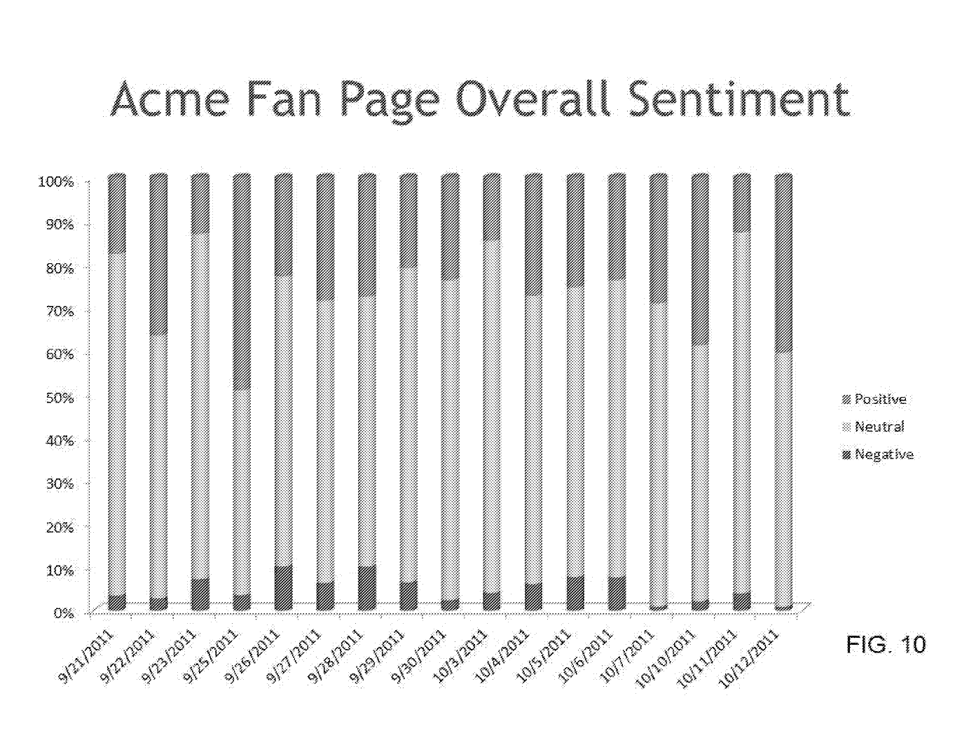

FIG. 10 illustrates example sentiment data associated with an entity's social audience. In this example, the positive sentiment is represented on the top of each column, the neutral sentiment is represented in the middle of each column, and the negative sentiment is represented at the bottom of each column.

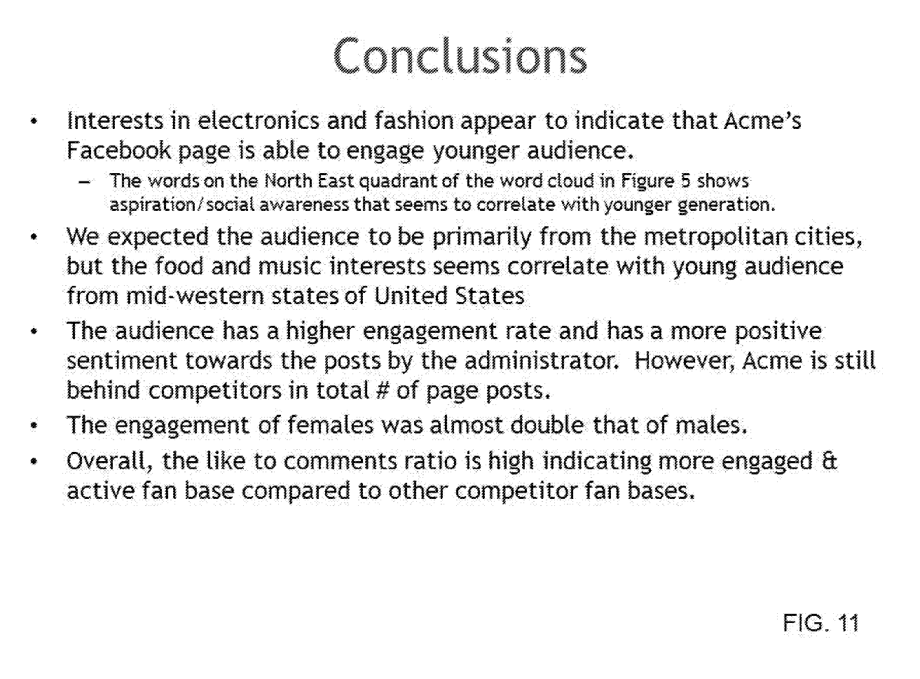

FIG. 11 illustrates example conclusions based on an entity's social audience. These conclusions are based, at least in part, on the data and analysis discussed herein.

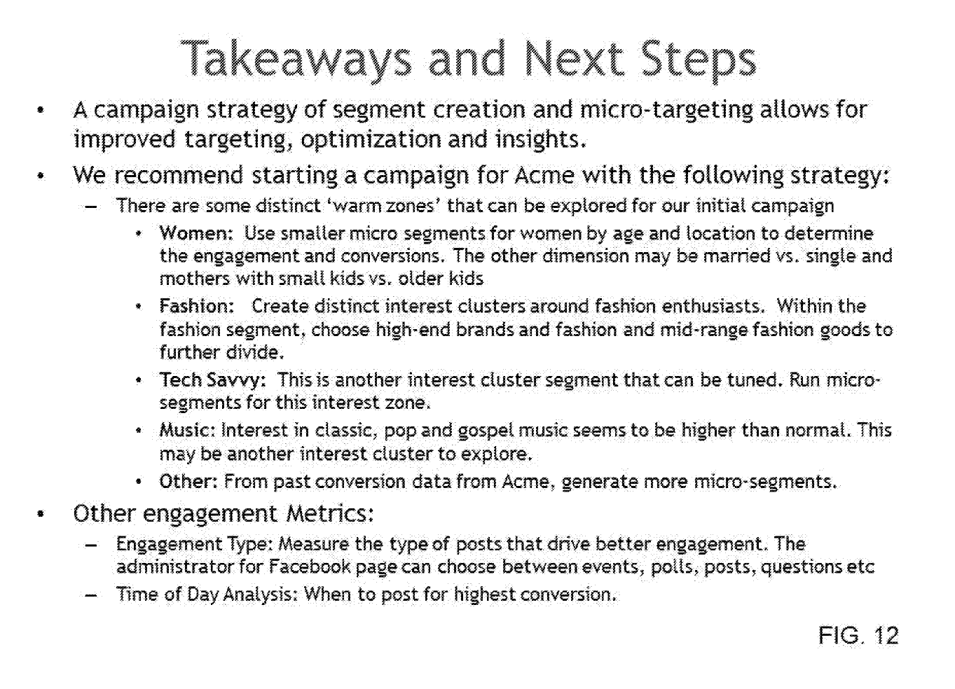

FIG. 12 illustrates example recommendations based on an entity's social audience. These recommendations are based, at least in part, on the data and analysis discussed herein.

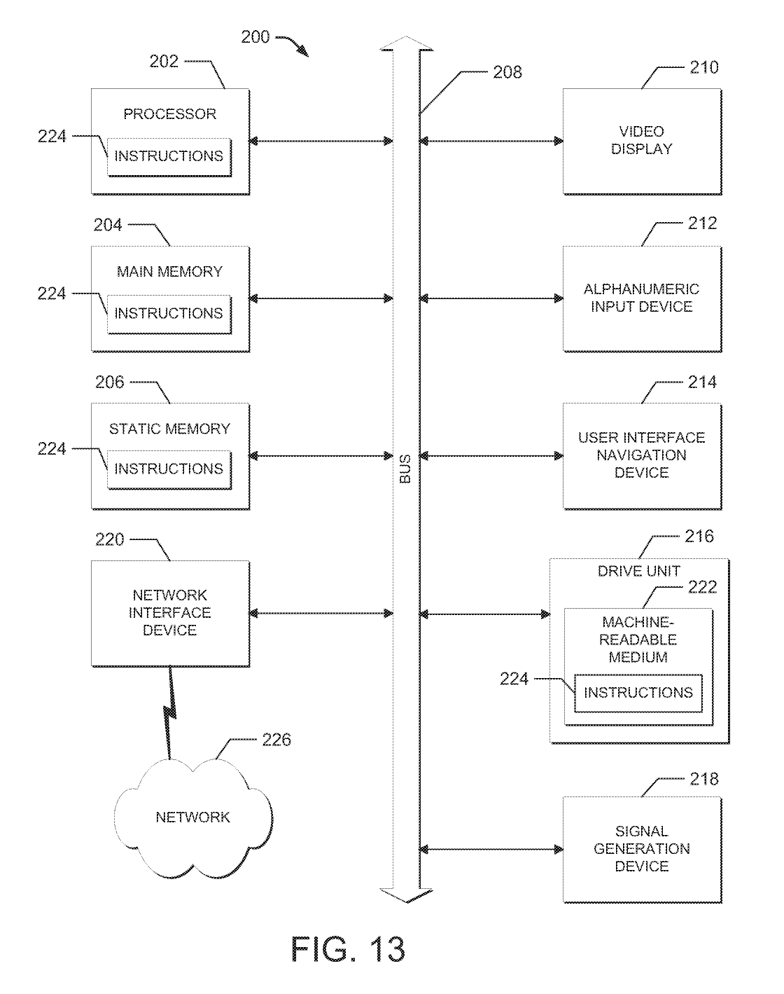

FIG. 13 is a block diagram of a machine in the example form of a computer system 200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 200 includes a processor 202 (e.g., a central processing unit (CPU), a graphics processing unit (GPU) or both), a main memory 204, and a static memory 206, which communicate with each other via a bus 208. Computer system 200 may further include a video display unit 210 (e.g., a liquid crystal display (LCD) or a cathode ray tube (CRT)). Computer system 200 also includes an alphanumeric input device 212 (e.g., a keyboard), a user interface (UI) navigation device 214 (e.g., a mouse), a disk drive unit 216, a signal generation device 218 (e.g., a speaker) and a network interface device 220.

Disk drive unit 216 includes a machine-readable medium 222 on which is stored one or more sets of instructions and data structures (e.g., software) 224 embodying or utilized by any one or more of the methodologies or functions described herein. Instructions 224 may also reside, completely or at least partially, within main memory 204, within static memory 206, and/or within processor 202 during execution thereof by computer system 200, main memory 204 and processor 202 also constituting machine-readable media.

While machine-readable medium 222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 224 may further be transmitted or received over a communications network 226 using a transmission medium. Instructions 224 may be transmitted using network interface device 220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving social audience data associated with a plurality of users;
passively identifying a plurality of preferences associated with the plurality of users based on the social audience data;
passively identifying demographic information associated with at least a portion of the plurality of users; and
determining, using one or more processors, at least one characteristic associated with the plurality of users based on the plurality of preferences and the demographic information.

2. A method comprising:
receiving social audience data associated with a plurality of users;
passively identifying a plurality of preferences associated with the plurality of users based on the social audience data;
passively identifying ownership information associated with at least a portion of the plurality of users; and
determining, using one or more processors, at least one characteristic associated with the plurality of users based on the plurality of preferences and the ownership information.

3. A method of analyzing social audience data, the method comprising:
receiving social audience data;
identifying a plurality of users associated with the social audience data who prefer a particular brand;
passively identifying characteristics associated with the plurality of users;
passively identifying ownership information associated with the plurality of users;
passively identifying interests associated with the plurality of users; and
analyzing, using one or more processors, the characteristics, ownership information, and interests associated with the plurality of users to determine how to attract the plurality of users.
